(19) United States
(12) Patent Application Publication
(10) Pub. No.: US 2026/0334732 A1
(43) Pub. Date: Oct. 29, 2026

(54) OVERMOLDED WHISK FOR A COOKING APPLIANCE

(71) Applicant: WHIRLPOOL CORPORATION, BENTON HARBOR, MI (US)

(72) Inventors: Michael Ronald Mackay, St. Joseph, MI (US); John Jay Myers, Saugatuck, MI (US); Aaron James Snyder, St. Joseph, MI (US); Evan Heike Sobetski, Shelby Twp., MI (US)

(73) Assignee: WHIRLPOOL CORPORATION, BENTON HARBOR, MI (US)

(21) Appl. No.: 19/187,620

(22) Filed: Apr. 23, 2025

(51) Int. Cl. A47J 43/07; A47J 43/044; B01F 27/053; B01F 27/112; B01F 27/114; B01F 27/119; B01F 101/06

(52) U.S. Cl. CPC A47J 43/0711; B01F 27/0531; B01F 27/112; B01F 27/114; B01F 27/119; A47J 2043/04454; B01F 2101/06

(57) ABSTRACT

A whisk for a stand mixer is formed of a hub member, a plurality of mixing wires, and a plurality of blades, wherein each mixing wire of the plurality of mixing wires is fixedly coupled with a corresponding pair of blades of the plurality of blades via an overmolding process. Further, each mixing wire has a first series of bends, and a second series of bends configured to facilitate the attachment of the plurality of blades to the plurality of mixing wires. Additionally, each of the plurality of mixing wires are orientated relative to a center-line of the whisk and to a corresponding plane to angle each of the plurality of blades downwards towards a bottom surface of the mixing bowl.

### BACKGROUND

The present disclosure generally relates to whisk for a cooking appliance, and more specifically, to a whisk for a stand mixer, wherein the whisk has a plurality of blades coupled with the whisk via an overmolding process.

### SUMMARY

According to one aspect of the present disclosure, a whisk for a cooking appliance includes a hub member configured to selectively couple with the cooking appliance, a first mixing wire fixedly coupled with the hub member, wherein the first mixing wire forms a first series of bends and a second series of bends, a first blade fixedly coupled with the first mixing wire, wherein the first series of bends is disposed within a first blade interior of the first blade, and a second blade is fixedly coupled with the first mixing wire, wherein the second series of bends is disposed within a second blade interior of the second blade.

According to yet aspect of the present disclosure, a whisk for a cooking appliance includes a hub member configured to selectively couple with the cooking appliance, a plurality of mixing wires fixedly coupled with the hub member, and a plurality of blades fixedly coupled with the plurality of mixing wires through an overmolding process, wherein each mixing wire of the plurality of mixing wires is fixedly coupled with a pair of blades of the plurality of blades.

According to yet another aspect of the present disclosure, a whisk for a cooking appliance includes a hub member configured to selectively couple with the cooking appliance, a first mixing wire fixedly coupled with the hub member, wherein the first mixing wire forms a first end, a second end opposite the first end, and a mid-section between the first end and the second end, wherein the mid-section is formed at a distal-most portion of the first mixing wire relative to the hub member, wherein the first end is positioned proximal to a first side of a plane that longitudinally extends from the hub member to the mid-section, the second end is positioned proximal to a second side of the plane, and the mid-section intersects the plane, and a blade, wherein the blade is fixedly coupled to the first mixing wire through an overmolding process.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side elevation view of a cooking appliance showing a whisk attached to the cooking appliance;

FIG. 2 is a side elevation view of the whisk showing a hub member, a plurality of mixing wires, and a plurality of blades that form the whisk;

FIG. 3 is a side elevation view of one of the mixing wires of the plurality of mixing wires of the whisk;

FIG. 4 a top pan view of the whisk with the plurality of blades removed, showing the orientation of each mixing wire of the plurality of mixing wires relative to a plane that corresponds with each mixing wire;

FIG. 5 is a side elevation view of one of the mixing wires of the plurality of mixing wires of the whisk with a pair of blades of the plurality of blades superimposed to show the attachment of the blades to the mixing wire;

FIG. 6 is a flow chart illustrating a method of manufacturing the whisk.

The components in the figures are not necessarily to scale, emphasis instead being placed upon illustrating the principles described herein.

### DETAILED DESCRIPTION

The present illustrated embodiments reside primarily in combinations of method steps and apparatus components related to a whisk for a cooking appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

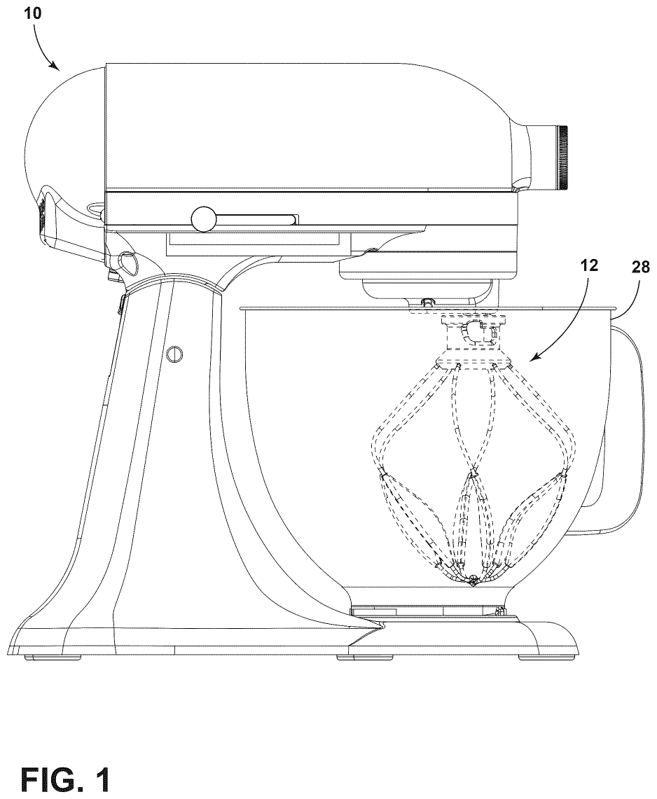

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such a process, method, article, or apparatus. An element preceded by “comprises a . . . ” does not, without more constraints, preclude the existence of additional identical elements in the process, method, article, or apparatus that comprises the element.

Referring to FIGS. 1-6, reference numeral 10 generally designates a cooking appliance 10. In the configuration illustrated in FIG. 1, the cooking appliance is a stand mixer 10 configured to mix cooking ingredients. A whisk 12 is selectively coupled to the stand mixer 10 and the whisk 12 has a hub member 14, a plurality of mixing wires 16, and a plurality of blades 18. The hub member 14 is selectively coupled with the stand mixer 10 and is configured to be operably linked with a drive mechanism of the stand mixer 10, such that the drive mechanism can rotate the hub member 14 and thereby the whisk 12. The plurality of mixing wires 16 are fixedly coupled with the hub member 14 and longitudinally extend from the hub member 14. Each of the plurality of mixing wires 16 has a first series of bends 20 and a second series of bends 22. The plurality of blades 18 are coupled with the plurality of mixing wires 16. Specifically, each of the plurality of mixing wires 16 is fixedly coupled with a corresponding pair of blades 18a, 18b of the plurality of blades 18. Additionally, each of the plurality of blades 18 are fixedly coupled with the respective mixing wire 16a, 16b, 16c of the plurality of mixing wires 16 through an overmolding process. In the overmolding process, the first and second series of bends 20, 22 of the respective mixing wire 16a, 16b, 16c are positioned within a mold and an overmold material is introduced to the mold to form and to fix the first and the second blades 18a, 18b to the first and second series of bends 20, 22, respectively.

Referring now to FIG. 1, the cooking appliance 10 is illustrated as the stand mixer 10. The stand mixer 10 is configured to mix one or more cooking ingredients within a mixing bowl 28 of the stand mixer 10. The whisk 12 is selectively attached to the stand mixer 10 to be selectively disposed within the mixing bowl 28 to mix the cooking ingredients within the mixing bowl 28.

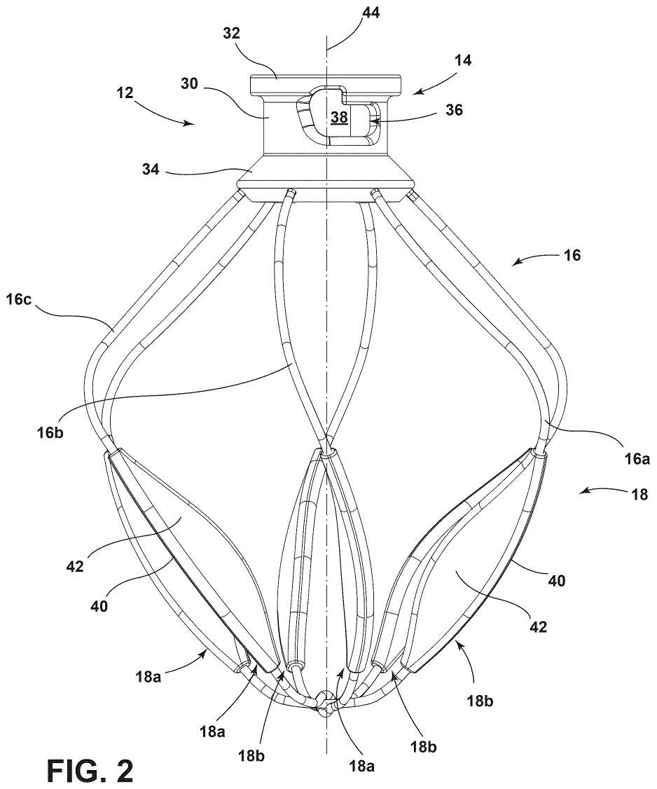

Referring now to FIG. 2, the whisk 12 has the hub member 14, the plurality of mixing wires 16, and the plurality of blades 18. The hub member 14 forms the proximal-most portion of the whisk 12 relative to the stand mixer 10 and is configured to facilitate the selective attachment of the whisk 12 to the stand mixer 10. The hub member 14 is formed of a tubular body 30, an upper flange 32 and a lower flange 34. The upper flange 32 is positioned at the proximal-most portion of the hub member 14 relative to the stand mixer 10 when the hub member 14 is selectively attached to the stand mixer 10. Further, the upper flange 32 annularly extends from the tubular body 30. The lower flange 34 is positioned at a distal-most portion of the hub member 14 relative to the stand mixer 10 and annularly extends from the tubular body 30. Additionally, a connection aperture 36 is formed by the hub member 14. Specifically, the connection aperture 36 is formed by both the tubular body 30 and the upper flange 32. The connection aperture 36 provides a passage into a hollow hub interior 38 of the hub member 14. Accordingly, the hub member 14, and thereby the whisk 12, can be selectively attached to the stand mixer 10, at least partially, via disposing a connection member of the stand mixer 10 within the hollow hub interior 38 via the connection aperture 36. Further, the connection aperture 36 may facilitate the creation of an operable connection between the whisk 12 and the stand mixer 10, such that the drive mechanism of the stand mixer 10 can rotate the hub member 14 and consequently, the whisk 12.

With continued reference to FIG. 2, the plurality of mixing wires 16 are fixedly attached to the hub member 14. Specifically, the plurality of mixing wires 16 are fixedly attached to the lower flange 34 of the hub member 14. From the hub member 14, each of the plurality of mixing wires 16 longitudinally extend away from the hub member 14 towards a bottom surface of the mixing bowl 28. As shown in the configuration illustrated in FIG. 2, the plurality of mixing wires 16 can include a first mixing wire 16a, a second mixing wire 16b, and a third mixing wire 16c. However, the plurality of mixing wires 16 may include an additional number of mixing wires beyond the three mixing wires 16a, 16b, and 16c illustrated in FIG. 2.

With continued reference to FIG. 2, the plurality of blades 18 are fixedly coupled to the plurality of mixing wires 16. Specifically, each mixing wire 16a, 16b, 16c is fixedly coupled with two blades, a first blade 18a and a second blade 18b. Each blade 18a, 18b forms a contact portion 40 and a fin 42. The contact portion 40 of each blade 18a, 18b faces outwards away from a center-line 44 of the whisk 12. The fin 42 of each blade 18a, 18b extends inwards from the contact portion 40 relative to the respective mixing wire 16a, 16b, 16c towards the center-line 44 of the whisk 12 and provides a blade surface. Additionally, the fin 42 of each blade 18a, 18b extends upwards towards the hub member 14. Together, the contact portion 40 and the fin 42 of each blade 18a, 18b can cooperate to provide each blade 18a, 18b with a substantially arcuate shape.

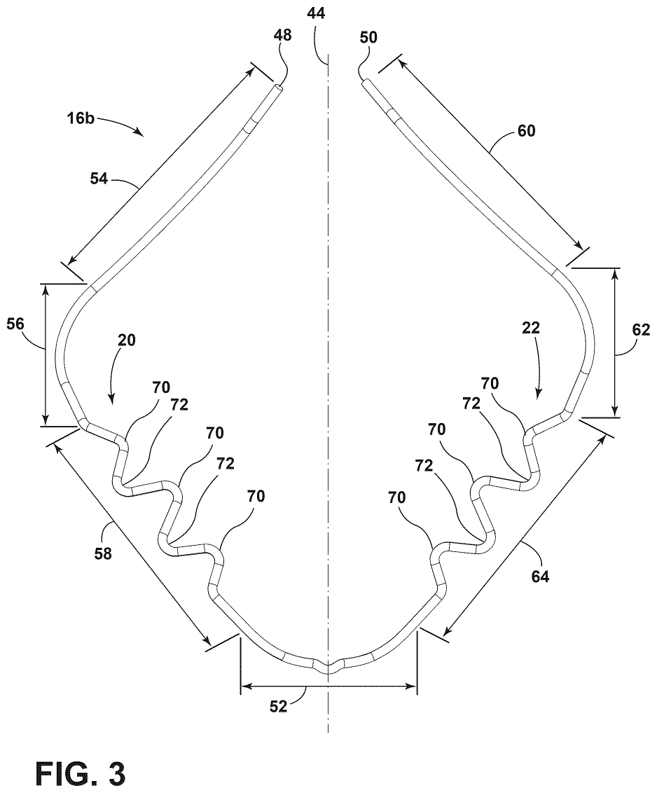

With reference now to FIG. 3, each of the plurality of mixing wires 16 is formed substantially of stainless steel. However, other non-corrosive and food safe materials may be used to form the plurality of mixing wires 16. Each of the plurality of mixing wires 16 has a substantially annular cross section and may be integrally formed, such that each mixing wire 16a, 16b, 16c is a single, unitary body. Additionally, each of the plurality of mixing wires 16 may have a first elasticity and the hub member 14 may have a second elasticity, wherein the first elasticity of each of the plurality of mixing wires 16 is greater than the second elasticity of the hub member 14. Accordingly, each of the plurality of mixing wires 16 is capable of flexing relative to the hub member 14 during an operation of the stand mixer 10. Additionally, the plurality of mixing wires 16 may be formed through a strand casting process or via a drawing manufacturing process.

With continued reference to FIG. 3, each of the plurality of mixing wires 16 may be substantially identical in form and composition. Specifically, each of the plurality of mixing wires 16 has a first end 48, a second end 50 opposite the first end 48, and a mid-section 52 formed between the first end 48 and the second end 50. The plurality of mixing wires 16 are fixedly coupled to the lower flange 34 of the hub member 14 by the respective first and second end 48, 50. Specifically, the first end 48 and the second end 50 of each of the plurality of mixing wires 16 are attached to opposite sides of the hub member 14. From the first and second ends 48, 50, each mixing wire 16a, 16b, 16c extends longitudinally away from the hub member 14 to form the mid-section 52 at a distal-most portion of the mixing wire 16a, 16b, 16c relative to the hub member 14. The mid-section 52 of each of the plurality of mixing wires 16 may cross the center-line 44 of the whisk 12, or otherwise be aligned with the center-line 44 of the whisk 12. When the whisk 12 is disposed within the interior of the mixing bowl 28, the mid-section 52 of each of the plurality of wires 16 may be the proximal-most portion of the whisk 12 relative to the bottom surface of the mixing bowl 28. Additionally, each of the plurality of mixing wires 16 has a substantially diamond shaped profile.

With continued reference to FIG. 3, each of the plurality of mixing wires 16 has a first upper extension 54, a first connection portion 56, and a first lower extension 58. The first upper extensions 54 extend from the first end 48 of the respective mixing wire 16a, 16b, 16c away from the center-line 44 of the whisk 12 and to the respective first connection portion 56. The first lower extension 58 of each mixing wire 16a, 16b, 16c extends from the respective first connection portion 56 towards the center-line 44 of the whisk 12 and to the mid-section 52 of the respective mixing wire 16a, 16b, 16c. Accordingly, the first connection portion 56 of each mixing wire 16a, 16b, 16c is interposed between the respective first upper extension 54 and the respective first lower extension 58. Further, the first connection portion 56 of each mixing wire 16a, 16b, 16c has a substantially arcuate form, allowing the first connection portions 56 to extend both away from and towards the center-line 44 of the whisk 12. Accordingly, the first connection portion 56 of each mixing wire 16a, 16b, 16c can facilitate the orientation of both the respective first upper extension 54 and the respective first lower extension 58 relative to the center-line 44, notwithstanding that the first upper extension 54, the first connection portion 56, and the first lower extension 58 of each mixing wire 16a, 16b, 16c can be integrally formed together as a single, unitary body.

With continued reference to FIG. 3, each mixing wire 16a, 16b, 16c also has a second upper extension 60, a second connection portion 62, and a second lower extension 64. The second upper extensions 60 extend from the second end 50 of the respective mixing wire 16a, 16b, 16c away from the center-line 44 of the whisk 12 to the respective second connection portion 62. The second lower extensions 64 extend from the respective second connection portion 62 towards the center-line 44 of the whisk 12 and to the mid-section 52 of the respective mixing wire 16a, 16b, 16c. Accordingly, the mid-section 52 of each mixing wire 16a, 16b, 16c is interposed between the first and second lower extension 58, 64 of the respective mixing wire 16a, 16b, 16c. Additionally, the second connection portions 62 are interposed between the respective second upper extension 60 and the respective second lower extension 64. Further, the second connection portions 62 have a substantially arcuate form, allowing the second connection portions 62 to extend both away from and towards the center-line 44 of the whisk 12. Accordingly, the second connection portions 62 can facilitate the orientation of both the second upper extensions 60 and the second lower extensions 64 relative to the center-line 44, notwithstanding that the second upper extension 60, the second connection portion 62, and the second lower extension 64 of each mixing wire 16a, 16b, 16c can be integrally formed as a single, unitary body.

With continued reference to FIG. 3, both the first and second connection portions 56, 62 partially define the maximum width of each of the plurality of mixing wires 16. Specifically, the curvature formed by the first connection portion 56 and the second connection portion 62 to accommodate the orientations of the respective upper and lower extensions 54, 60, 58, 64, is partially determinative of the maximum width of the respective mixing wire 16a, 16b, 16c. As such, reducing the angle between the first upper and lower extensions 54, 58, as well as between the second upper and lower extensions 60, 64 increases the width of the respective mixing wire 16a, 16b, 16c, as the curvature of the respective connection portions 56, 62 deviates from a substantially straight line to accommodate the orientation of the respective upper and lower extensions 54, 60, 58, 64.

With continued reference to FIG. 3, the portions of each mixing wire 16a, 16b, 16c formed by the respective upper extensions 54, 60, lower extensions 58, 64, and connecting portions 56, 62 have substantially equivalent dimensions. Consequently, each mixing wire 16a, 16b, 16c is substantially symmetric across a center-line of the mixing wire 16a, 16b, 16c.

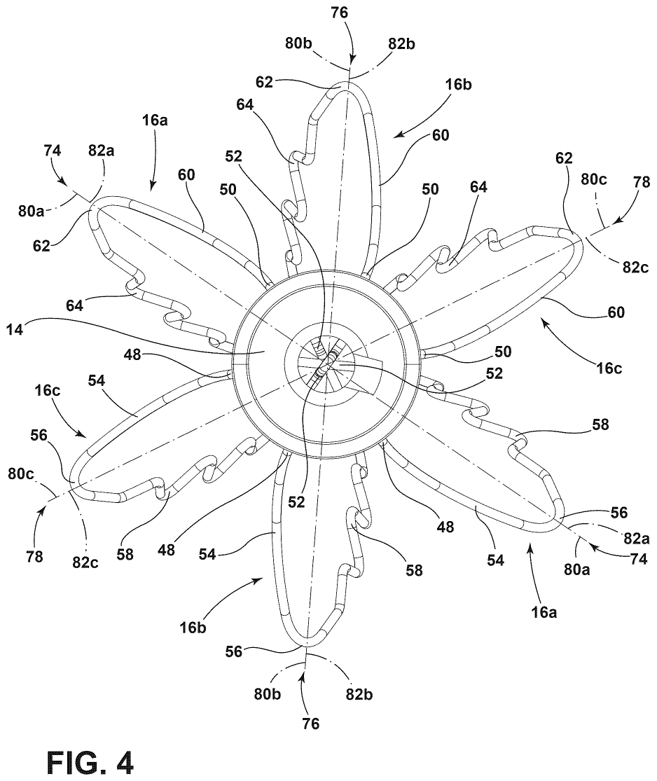

With reference now to FIG. 4, each of the mixing wires 16a, 16b, 16c has a corresponding plane 74, 76, 78 that extends longitudinally between the hub member 14 to the mid-section 52 of the respective mixing wire 16a, 16b, 16c. Further, the corresponding plane 74, 76, 78 extends laterally between the first connection portion 56 and the second connection portion 62 of the corresponding mixing wire 16a, 16b, 16c. Each plane 74, 76, 78 is bisected by the center-line 44 of the whisk 12 such that the planes 74, 76, 78 may divide the whisk 12 into substantially equivalent sections. As shown in FIG. 4, the first mixing wire 16a is associated with a first plane 74, the second mixing wire 16b is associated with a second plane 76, and the third mixing wire 16c is associated with a third plane 78. The first end 48 of each mixing wire 16a, 16b, 16c is proximal to a first side 80a, 80b, 80c of the corresponding plane 74, 76, 78. The second end 50 of each mixing wire 16a, 16b, 16c is proximal to a second side 82a, 82b, 82c of the respective plane 74, 76, 78. Consequently, each mixing wire 16a, 16b, 16c crosses the respective plane 74, 76, 78 as the mixing wires 16, 16b, 16c longitudinally extends from the hub member 14. Specifically, the first upper extension 54 of each mixing wire 16a, 16b, 16c is positioned proximal to the first side 80a, 80b, 80c of the respective plane 74, 76, 78. The first connection portion 56 of each mixing wire 16a, 16b, 16c then passes through, or intersects the respective plane 74, 76, 78. Accordingly, the first lower extension 58 of each mixing wire 16a, 16b, 16c is positioned proximal to the second side 82a, 82b, 82c of the respective plane 74, 76, 78. The mid-section 52 of each mixing wire 16a, 16b, 16c then passes through, or intersects the respective plane 74, 76, 78, such that the second lower extension 64 of each mixing wire 16a, 16b, 16c is positioned proximal to the first side 80a, 80b, 80c of the respective plane 74, 76, 78. The second connection portion 62 of each mixing wire 16a, 16b, 16c then passes through, or intersects the respective plane 74, 76, 78. Accordingly, the second upper extension 60 of each mixing wire 16a, 16b, 16c is positioned proximal to the second side 82a, 82b, 82c of the respective plane 74, 76, 78. Consequently, each mixing wire 16a, 16b, 16c passes through, or intersects, the respective plane 74, 76, 78 a plurality of instances as the mixing wires 16a, 16b, 16c longitudinally extend from the hub member 14.

As a consequence of the orientation of each mixing wire 16a, 16b, 16c relative to the respective plane 74, 76, 78, as shown best in both FIGS. 2 and 4, each mixing wire 16a, 16b, 16c has a generally helical form. Further, when viewed from above, each of the mixing wires 16a, 16b, 16c is shaped substantially similar to a lemniscate with two central loops intersecting at the respective mid-section 52 of each mixing wire 16a, 16b, 16c.

As shown in FIG. 4, the plurality of mixing wires 16 can include a first, a second, and a third mixing wire 16a, 16b, 16c, each associated with a respective plane 74, 76, 78. However, the plurality of mixing wires 16 may include additional mixing wires that are oriented with respect to an associated plane in a similar manner as the first, second, and third mixing wires 16a, 16b, 16c that have been previously described.

With reference back to FIG. 3, each of the plurality of mixing wires 16 forms a first series of bends 20 and a second series of bends 22. Both the first and second series of bends 20, 22 include a plurality of inwardly extending bends 70 and a plurality of outwardly extending bends 72. Each inwardly extending bend of the plurality of inwardly extending bends 70 extends towards the center-line 44 of the whisk 12. Each outwardly extending bend of the plurality of outwardly extending bends 72 extends away from the center-line 44 of the whisk 12. Further, each inwardly extending bend 70 may extend towards the center-line 44 of the whisk 12 for a first length and each outwardly extending bend 72 may extend away from the center-line 44 of the whisk 12 for a second length. The first length and the second length may be substantially equivalent, such that the plurality of inwardly and outwardly extending bends 70, 72 cooperate to provide the respective series of bends 20, 22 with a generally sinusoidal form. However, one or more of either the plurality of inwardly extending bends 70 and/or outwardly extending bends 72 may extend for a length greater or less than the other inwardly and/or outwardly extending bends 70, 72.

With continued reference to FIG. 3, each mixing wire 16a, 16b, 16c forms the first series of bends 20 at the first lower extension 58 of the respective mixing wire 16a, 16b, 16c. Further, each mixing wire 16a, 16b, 16c forms the second series of bends 22 at the second lower extension 64 of the respective mixing wire 16a, 16b, 16c. Consequently, the first and second series of bends 20, 22 are generally curved in accordance with the general curve of the first and second lower extensions 58, 64.

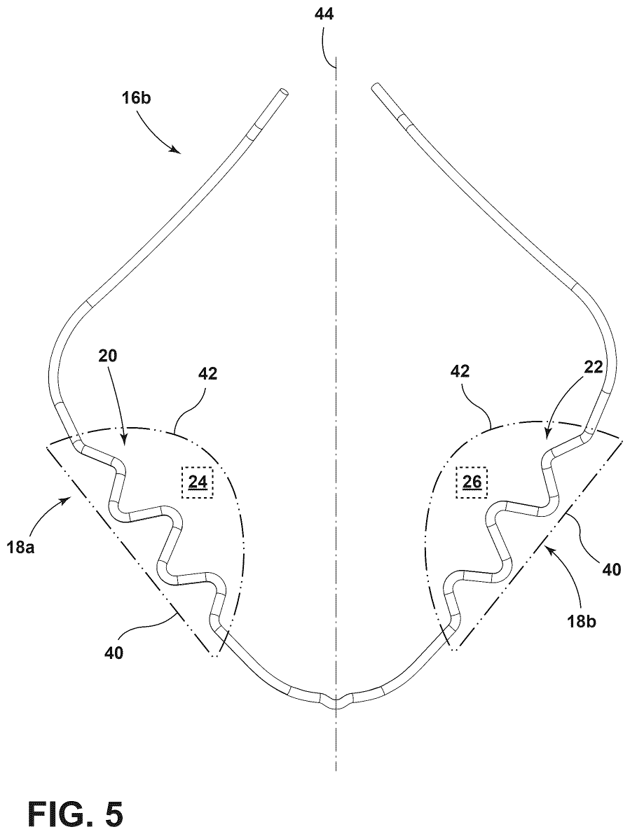

With reference now to FIG. 5, each blade of the plurality of blades 18 is attached with the respective mixing wire 16a, 16b, 16c via either the first or second series of bends 20, 22. Specifically, the first series of bends 20 is embedded, or otherwise disposed within the first blade interior 24 of the first blade 18a and the second series of bends 22 is embedded, or otherwise disposed within a second blade interior 26 of the second blade 18b. Consequently, both the first and second blades 18a, 18b may curve in accordance with the curve of the corresponding first and second lower extension 58, 64. Further, the blade surfaces formed by the fin 42 of the first blade 18a and the fin 42 of the second blade 18b may be a non-planar surface, as the blade surfaces curve, or generally bend, in accordance with the curve of the respective lower extension 58, 64. Specifically, as shown best in FIG. 2, the blades 18a, 18b may be angled, or otherwise deflected, towards the bottom surface of the mixing bowl 28 as a function of the orientation of the mixing wires 16a, 16b, 16c relative to the associated plane 74, 76, 78. Consequently, in operation, when the whisk 12 is driven to rotate by the drive mechanism of the stand mixer 10, the downwards deflection of each of the blades 18a, 18b can function to drive ingredients being mixed towards the bottom of the mixing bowl 28. Consequently, the ingredients can be maintained within the mixing bowl 28, reducing the amount of ingredients that may splash out of the mixing bowl 28.

With continued reference to FIG. 5, the series of bends 20, 22 formed by each mixing wire 16a, 16b, 16c may be substantially disposed within the respective blade interior 24, 26, such that each of the plurality of inwardly extending bends 70 and each of the plurality of outwardly extending bends 72 are received within the respective blade interior 24, 26. The attachment of each of the blades 18a, 18b over the series of bends 20, 22 strengthens the overall structure of the whisk 12. Specifically, the series of bends 20, 22 provides an increased surface area, relative to a non-curved, linear extension of the mixing wires 16a, 16b, 16c, thereby facilitating the attachment of the blades 18a, 18b. Further, the formation of the series of bends 20, 22 by each mixing wire 16a, 16b, 16c at least partially functions to facilitate the overmolding of the plurality of blades 18 to the plurality of mixing wires 16.

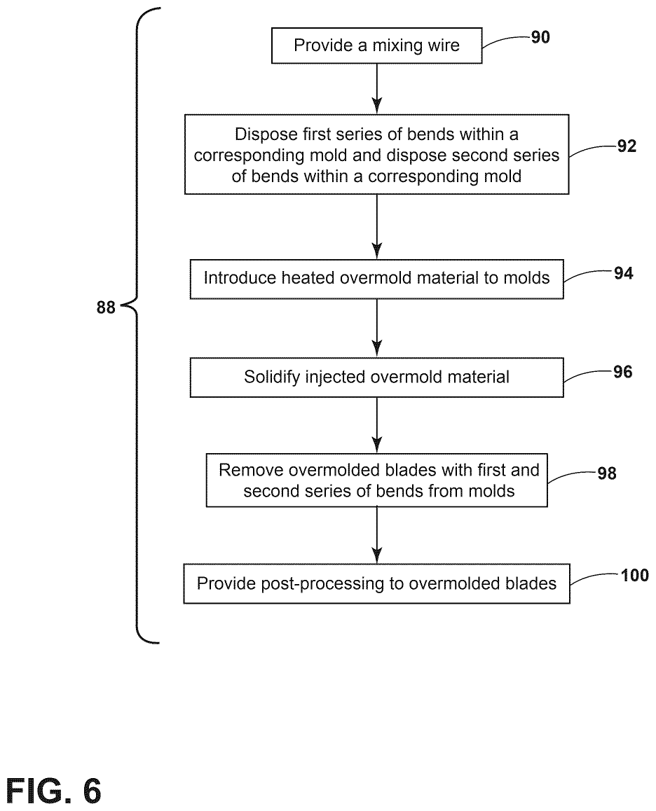

With reference now to FIGS. 5 and 6, each blade of the plurality of blades 18 may be attached to the plurality of mixing wires 16 via an overmolding process. An exemplary illustration of an overmolding method 88 that may be utilized is provided in FIG. 6. At step 90, one of the wires of the plurality of mixing wires 16 is provided. At step 92, the first series of bends 20 of the mixing wire 16 is disposed within a mold, that forms a cavity that corresponds to the shape of the first blade 18a. Likewise, at step 92, the second series of bends 22 is disposed within a mold that forms a cavity that corresponds to the shape of the second blade 18b. Alternatively, the first and second series of bends 20, 22 may each be disposed within a single mold that forms a divided cavity that corresponds to the shape of both the first and second blades 18a, 18b. At step 94, a heated fluid overmold material is injected, or otherwise introduced, into both of the molds. The overmold material can be a thermoplastic elastomer, a silicone, or another material that is both food-safe and flexible upon solidification. At step 96, the injected overmold material is cooled until the overmold material solidifies, forming each of the blades 18a, 18b. Additionally, at step 96, pressure may be applied to the injected overmold material to further facilitate the solidification and formation of the blades 18a, 18b. At step 98, the series of bends 20, 22 with the blades 18a, 18b are ejected, or otherwise removed from the molds. Additional post-processing steps can also be performed at step 100, such as trimming excess material from the blades 18a, 18b, polishing the blades 18a, 18b, and/or providing an additional coating or finishing layer to the blades 18a, 18b.

Use of the present concept may provide a variety of advantages. First, the overall geometry of the whisk 12, created by the orientation of the upper and lower extensions 54, 60, 58, 64 of each mixing wire 16a, 16b, 16c relative to the center-line 44 of the whisk 12 and to the associated plane 74, 76, 78, functions to urge mixing ingredients towards the bottom of the mixing bowl 28 during a mixing process. Specifically, the curvature of the upper and lower extensions 54, 60, 58, 64 of each mixing wire 16a, 16b, 16c as each mixing wire 16a, 16b, 16c longitudinally extends from the hub member 14 functions to drive the mixing ingredients towards the bottom of the mixing bowl 28. Further, the downwards angle of each of the blades 18a, 18b that results from the orientation of the mixing wires 16a, 16b, 16c functions to drive mixing ingredients towards the bottom of the mixing bowl 28. Accordingly, mixing ingredients can be maintained within the mixing bowl 28, preventing mixing ingredients from splashing out of the mixing bowl 28. Second, as mentioned previously, the series of bends 20, 22 formed by each of the plurality of mixing wires 16 facilitate the attachment of the plurality of blades 18 to the plurality of mixing wires 16. As such, each of the plurality of blades 18 can be overmolded onto the corresponding mixing wire 16a, 16b, 16c. The use of an overmolding process allows for the creation of a whisk 12 wherein the plurality of mixing wires 16 and the plurality of blades 18 are formed of separate materials. Further, the use of the overmolding process creates additional efficiencies in the manufacturing process. Specifically, in the manufacturing process, less material is required to form the plurality of blades 18 relative to if both the plurality of mixing wires 16 and the plurality of blades 18 were formed as a single unit. Additionally, the use of an overmolding process allows for greater flexibility in design, as the specific shape of each of the plurality of blades 18 can be easily adjusted through changing the dimensions of the cavity of the respective mold.

According to one aspect of the present disclosure, a whisk for a cooking appliance includes a hub member configured to selectively couple with the cooking appliance, a first mixing wire fixedly coupled with the hub member, wherein the first mixing wire forms a first series of bend and a second series of bends, a first blade fixedly coupled with the first mixing wire, wherein the first series of bends is disposed within a first blade interior of the first blade, and a second blade fixedly coupled with the first mixing wire, wherein the second series of bends is disposed within a second blade interior of the second blade.

According to another aspect of the present disclosure, the first mixing wire is fixedly coupled to the hub member by a first end of the first mixing wire and a second end of the first mixing wire, wherein the first mixing wire longitudinally extends from the first end and the second end to form a mid-section at a distal-most portion of the first mixing wire relative to the hub member.

According to another aspect of the present disclosure, the first series of bends is formed between the first end and the mid-section of the first mixing wire, and the second series of bends is formed between the second end and the mid-section of the first mixing wire.

According to another aspect of the present disclosure, the first blade is positioned between the first end and the mid-section of the first mixing wire, and the second blade is positioned between the second end and the mid-section of the first mixing wire.

According to another aspect of the present disclosure, the first series of bends includes a plurality of inwardly extending bends, wherein each bend of the plurality of inwardly extending bends extends towards a center-line of the whisk, and a plurality of outwardly extending bends, wherein each of the plurality of outwardly extending bends extends away from the center-line of the whisk.

According to another aspect of the present disclosure, each bend of the plurality of inwardly extending bends extends towards the center-line of the whisk for a first length, and each bend of the plurality of outwardly extending bends extends away from the center-line of the whisk for a second length, wherein the first length is substantially equivalent to the second length.

According to another aspect of the present disclosure, the first blade is fixedly coupled to the first mixing wire via an overmolding process, wherein the first series of bends is positioned within a mold and a heated overmold material is injected into the mold to form the first blade.

According to another aspect of the present disclosure, the first blade and the second blade are formed substantially of a thermoplastic elastomer.

According to another aspect of the present disclosure, the first mixing wire is formed substantially of stainless steel.

According to another aspect of the present disclosure, the first mixing wire has an annular cross-section.

According to yet another aspect, a whisk for a cooking appliance includes a hub member configured to selectively couple with the cooking appliance, a plurality of mixing wires fixedly coupled with the hub member, and a plurality of blades fixedly coupled with the plurality of mixing wires through an overmolding process, wherein each mixing wire of the plurality of mixing wires is fixedly coupled with a pair of blades of the plurality of blades.

According to another aspect of the present disclosure, each mixing wire of the plurality of mixing wires forms a first end, a second end opposite the first end, and a mid-section between the first end and the second end, wherein each mid-section is formed at a distal-most portion of the respective mixing wire of the plurality of mixing wires relative to the hub member, wherein each mixing wire of the plurality of mixing wires is fixedly coupled with the hub member via the respective first end and the respective second end.

According to another aspect of the present disclosure, each blade of the plurality of blades forms a fin, wherein the fin of each blade of the plurality of blades extends towards a center-line of the whisk.

According to another aspect of the present disclosure, each blade of the plurality of blades forms a fin, wherein the fin of each blade of the plurality of blades extends towards the hub member.

According to another aspect of the present disclosure, each blade of the plurality of blades is formed substantially of a thermoplastic elastomer.

According to another aspect of the present disclosure, each mixing wire of the plurality of mixing wires is formed substantially of stainless steel.

According to yet another aspect, a whisk for a cooking appliance includes a hub member configured to selectively couple with the cooking appliance, a first mixing wire fixedly coupled with the hub member, wherein the first mixing wire forms a first end, a second end opposite the first end, and a mid-section between the first end and the second end, wherein the mid-section is formed at a distal-most portion of the first mixing wire relative to the hub member, wherein the first end is positioned proximal to a first side of a plane that longitudinally extends from the hub member to the mid-section, the second end is positioned proximal to a second side of the plane, and the mid-section intersects the plane, and a first blade, wherein the first blade is fixedly coupled to the first mixing wire through an overmolding process.

According to another aspect of the present disclosure, the first mixing wire forms a first upper extension that extends from the first end away from a center-line of the whisk to a first connection portion formed by the first mixing wire, and a first lower extension that extends from the first connection portion towards the center-line of the whisk and to the mid-section of the first mixing wire.

According to another aspect of the present disclosure, the first upper extension is positioned proximal to the first side of the plane, and the first lower extension is positioned proximal to the second side of the plane.

According to another aspect of the present disclosure, the first lower extension forms a first series of bends, wherein the first series of bends is disposed within a first blade interior of the first blade.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A whisk for a cooking appliance, comprising:
a hub member configured to selectively couple with said cooking appliance;
a first mixing wire fixedly coupled with the hub member, wherein the first mixing wire forms:
a first series of bends, and
a second series of bends;
a first blade fixedly coupled with the first mixing wire, wherein the first series of bends is disposed within a first blade interior of the first blade; and
a second blade fixedly coupled with the first mixing wire, wherein the second series of bends is disposed within a second blade interior of the second blade.

2. The whisk for a cooking appliance of claim 1, wherein the first mixing wire is fixedly coupled to the hub member by a first end of the first mixing wire and a second end of the first mixing wire, wherein the first mixing wire longitudinally extends from the first end and the second end to form a mid-section at a distal-most portion of the first mixing wire relative to the hub member.

3. The whisk for a cooking appliance of claim 2, wherein the first series of bends is formed between the first end and the mid-section of the first mixing wire, and the second series of bends is formed between the second end and the mid-section of the first mixing wire.

4. The whisk for a cooking appliance of claim 2, wherein the first blade is positioned between the first end and the mid-section of the first mixing wire, and the second blade is positioned between the second end and the mid-section of the first mixing wire.

5. The whisk for a cooking appliance of claim 1, wherein the first series of bends comprises:
a plurality of inwardly extending bends, wherein each of the plurality of inwardly extending bends extends towards a center-line of said whisk; and
a plurality of outwardly extending bends, wherein each of the plurality of outwardly extending bends extends away from the center-line of said whisk.

6. The whisk for a cooking appliance of claim 5, wherein each bend of the plurality of inwardly extending bends extends towards the center-line of said whisk for a first length, and each bend of the plurality of outwardly extending bends extends away from the center-line of said whisk for a second length, wherein the first length is substantially equivalent to the second length.

7. The whisk for a cooking appliance of claim 1, wherein the first blade is fixedly coupled to the first mixing wire via an overmolding process, wherein the first series of bends is positioned within a mold and a heated overmold material is injected into the mold to form the first blade.

8. The whisk for a cooking appliance of claim 1, wherein the first blade and the second blade are formed substantially of a thermoplastic elastomer.

9. The whisk for a cooking appliance of claim 1, wherein the first mixing wire is formed substantially of stainless steel.

10. The whisk for a cooking appliance of claim 1, wherein the first mixing wire has an annular cross-section.

11. A whisk for a cooking appliance, comprising:
a hub member configured to selectively couple with said cooking appliance;
a plurality of mixing wires fixedly coupled with the hub member; and
a plurality of blades fixedly coupled with the plurality of mixing wires through an overmolding process, wherein each mixing wire of the plurality of mixing wires is fixedly coupled with a pair of blades of the plurality of blades.

12. The whisk for a cooking appliance of claim 11, wherein each mixing wire of the plurality of mixing wires forms a first end, a second end opposite the first end, and a mid-section between the first end and the second end, wherein each mid-section is formed at a distal-most portion of the respective mixing wire of the plurality of mixing wires relative to the hub member, wherein each mixing wire of the plurality of mixing wires is fixedly coupled with the hub member via the respective first end and the respective second end.

13. The whisk for a cooking appliance of claim 11, wherein each blade of the plurality of blades forms a fin, wherein the fin of each blade of the plurality of blades extends towards a center-line of said whisk.

14. The whisk for a cooking appliance of claim 11, wherein each blade of the plurality of blades forms a fin, wherein the fin of each blade of the plurality of blades extends towards the hub member.

15. The whisk for a cooking appliance of claim 11, wherein each blade of the plurality of blades is formed substantially of a thermoplastic elastomer.

16. The whisk for a cooking appliance of claim 11, wherein each mixing wire of the plurality of mixing wires is formed substantially of stainless steel.

17. A whisk for a cooking appliance, comprising:
a hub member configured to selectively couple with said cooking appliance;
a first mixing wire fixedly coupled with the hub member, wherein the first mixing wire forms a first end, a second end opposite the first end and a mid-section between the first end and the second end, wherein the mid-section is formed at a distal-most portion of the first mixing wire relative to the hub member, wherein the first end is positioned proximal to a first side of a plane that longitudinally extends from the hub member to the mid-section, the second end is positioned proximal to a second side of the plane, and the mid-section intersects the plane; and
a first blade, wherein the first blade is fixedly coupled to the first mixing wire through an overmolding process.

18. The whisk for a cooking appliance of claim 17, wherein the first mixing wire forms:
a first upper extension that extends from the first end away from a center-line of the whisk to a first connection portion formed by the first mixing wire; and
a first lower extension that extends from the first connection portion towards the center-line of the whisk and to the mid-section of the first mixing wire.

19. The whisk for a cooking appliance of claim 18, wherein the first upper extension is positioned proximal to the first side of the plane, and the first lower extension is positioned proximal to the second side of the plane.

20. The whisk for a cooking appliance of claim 19, wherein the first lower extension forms a first series of bends, wherein the first series of bends is disposed within a first blade interior of the first blade.
